(19) United States
(12) Patent Application Publication
(10) Pub. No.: US 2018/0365684 A1
(43) Pub. Date: Dec. 20, 2018

(54) CURRENCY TRADING PLATFORM AND SERVICE

(71) Applicant: Mill Lane Productions, Lewes, DE (US)

(72) Inventors: Thomas Reilly, Bedminster, NJ (US); Gregory Hirsch, Branchburg, NJ (US)

(21) Appl. No.: 15/622,093

(22) Filed: Jun. 14, 2017

(51) Int. Cl. G06Q 20/38; G06Q 20/06

(52) U.S. Cl. CPC G06Q 20/381; G06Q 20/06

(57) ABSTRACT

A computer-implemented method and a computer system for matching parties for a currency exchange transaction. Account information for each of multiple users is stored, the account information including for each user including identity information. Currency exchange request messages are received from at least two of the multiple users, wherein each currency exchange request messages include information indicating the account of the user an origination currency, a target currency, and an amount of either the origination or the target currency desired for trade. Parties are matches for a currency exchange transaction based on the currency exchange request messages and put in communication with one another to complete a transaction.

### BACKGROUND

There are many types of currency throughout the world. Many currencies are backed by a nation or a group of nations and are represented by coins or paper money. More recently, crypto currencies have become popular. Cryptocurrencies use digital tokens and ownership is represented by a ledger that is cryptographically secured. Accordingly, there are hundreds of currencies throughout the world having various values and points of acceptance. The relative value of currencies, i.e., the exchange rate, is very dynamic and is a function of many economic and political variables of each country.

Complex currency exchange markets have developed in which investors trade the various currencies as an investment vehicle. However, most people use a single primary currency, usually that of the country in which they reside and rarely need to exchange large amounts of currencies. However, when travelling, it is often necessary to exchange currency, i.e., purchase some of the currency of the traveler's destination country using currency of the traveler's home country. On return to the traveler's home country, the traveler will often have unused currency of the destination country and will desire to exchange that currency for currency of their home country. Traveler currency transactions are often for relatively small amounts. However, the transaction still must go through the conventional banking system, which is not efficient for small transactions. Therefore, the traveler will often pay a high exchange fee, get an under-market exchange rate, or both, when exchanging currency. For travelers without access to a bank, currency exchange can be very inconvenient.

Currency exchange services often have a retail presence at airports, train stations, and other entry and exit points of a country. Such services post current exchange rates. In most cases the exchange rate for Currency A to Currency B is not the inverse of the exchange rate for currency B to currency A. Further, such services charge a transaction fee. As an example, a traveler at a train station in the UK may exchange 100 bps for 110 Euros, an exchange rate of 1.1 Euros to 1 bps, in the morning. That same traveler might return several hours later with 50 euros but only get 50 bps in exchange, an exchange rate of 1 euro to 1 bps. Additionally, the service may charge a percentage fee for each transaction, usually more than banks. Total fees sometimes run upwards of 25 percent.

### BRIEF DESCRIPTION OF THE DRAWING

The foregoing summary, as well as the following detailed description of the embodiments, will be better understood when read in connection with the appended drawing. It should be understood, however, that the invention is not limited to the precise arrangements and instrumentalities shown in the drawing:

FIG. 1 is a schematic block diagram of a computer architecture of the disclosed embodiment; and

FIGS. 2-11 are screenshots of the client device user interface of an embodiment.

### DETAILED DESCRIPTION

Certain terminology is used in the following description for convenience only and is not limiting. For example, unless specifically set forth herein, the terms “a,” “an” and “the” are not limited to one element but instead should be read as meaning “at least one.” The terminology includes the words noted above, derivatives thereof and words of similar import. The embodiments are described through functional modules. The term “module”, as used herein, refers to software, i.e. computer executable instructions, stored in a non-transient manner and executed by a computer processor to carry out a specified function. The modules described herein are segregated by function for the purposes of description. However, a specific module can be distributed over on one or more computing devices and a specific computing device can be part of one or more modules. The various devices can exchange information using any known protocols and networks. For example, the network can be the internet using TCP/IP protocol.

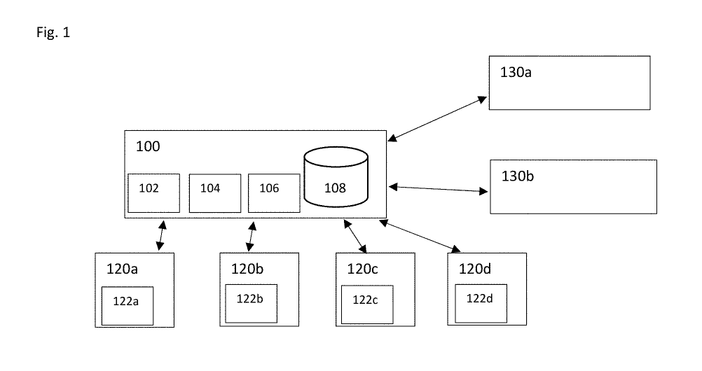

The inventors have determined that there is a need for a more efficient currency exchange platform that allows travelers to trade currency without the need to access the conventional banking system. The invention is a computing platform that matches parties with counterparties and allows direct peer to peer exchange and clearing of currency trades. The invention can be implemented in a peer to peer architecture or in a client server architecture. As illustrated in FIG. 1, the platform includes user devices 120a through 120d. Of course, there can be any number of user devices. As an example, a user device can be a mobile phone running an app that executes the user modules 122a, 122b, 122c, and 122d described below. Each user device, and the corresponding user module, are associated with a user. Users can register their devices and establish and account with the platform by sending a registration message to messaging module 102 of server 100. The registration message can include user identity information and any other information. The registration results in a user account the identifies the user device with the platform in a known manner. Of course, the registration can be accomplished using an existing account such as a GMAIL™, APPLE™ or FACEBOOK™ account.

Server 100 communicates with user devices 120a to 120d (also referred to as client devices herein), as needed to receive an exchange request message, through messaging module 102, from a specific user device. The exchange request message can indicate the currency the user possesses (an “originating currency”) and the amount thereof as well and the currency the user is looking for in exchange (a “target currency”). The exchange message can also have a time stamp an information indicating a location of the corresponding user. The location can be derived from a GPS module in the user device or from a user input, for example. Server 100 includes matching module 104 which processes the exchange request messages from multiple user devices 120a to 120d. User devices 120a-120d can be ay type of computing device but preferably are mobile devices such as smartphones. This allows the user to use the platform from anywhere, such as an airport, train station, or border crossing.

Matching module 104 includes a pool of match data from various exchange request messages and matches user devices based on the information in the pool. The data can be stored in database 108. For example, if exchange request Message X has a target currency that corresponds to the originating currency of exchange request message Y, exchange request message Y has a target currency that corresponds to the originating currency of exchange request message X, and the locations in each message are near one another, matching module 104 could match the user device sending exchange request message X with the user device sending exchange message Y. In such a case, notification module 104 will notify each of the matched user devices with a notification message including instructions for how the users of the matched devices can locate each other.

Server 100 can communicate with rate service 130a periodically to obtain current exchange rates for various currencies. The exchange rates can be stored in database 108 in a known manner. Exchange rates can be included in the notification messages. Exchange rates can be updated just prior to each notification message or in any other periodic manner. Also, the user receiving a notification message can accept the match or reject the match. For example, if the exchange rate is not acceptable to a user or the location of the counterparty is not convenient, the user may reject the match and matching module 104 will put the transaction back into a pool to be matched. Alternatively, a match can be made by sending only one user a message containing one or more possible matches and the user can then select and contact the most preferred counterparty. In any matching workflow, messaging module receives a confirmation of the match to adjust the matching pool. An example matching algorithm and process flow are disclosed in more detail below.

Once a match is confirmed. A transaction fee can be charged to the user accounts and the users (party and counterparty) are transitioned to chat or another mechanism of communication, where they work out arrangements to meet and exchange the currency that will finalize the transaction in a peer to peer manner. User rating module 106 communicates with user devices 120a-120d to allow users to rate one another based on various parameters. This information can be collated in database 108 and processed into user ratings to allow the community of users to police one another and only do business with those that have demonstrated trustworthiness.

One problem with currency trading in small amounts is how to most accurately and efficiently match parties and counterparties. Unlike, currency trading investors, travelers are more likely to be concerned with speed and convenience of personal interaction than exchanges rates and precise values. The inventors have developed a matching process that is optimized for small currency trading, such as trades by travelers for local currency. As an example of matching, two currencies are matched based on mutual demand that one party has for the other party's currency. The currencies are capped to the one with the lower amount. The lower value determines the limits of what gets traded.

If one party has $100 and is looking to swap for Euro, and the other partner has 100 Euro, the starting baseline will be $100 (euro equivalent based on the exchange rate) because it's the lesser of the two amounts. The example algorithm of matching module 104 takes the denominations held by the euro holding party (in this example 1×50, 1×20, 2×10, 1×5, 5×1) and accrues them, starting at the top (50) and working down (50+20 . . . ) until the sum gets to a predetermined threshold, f 70% of the whole in this example (in this case $70). At that point, the algorithm of matching module 104 begins adding from the bottom (50+20+1 . . . ) until it gets to 5 bills/coins remaining. When 5 bills/coins remain, the algorithm runs through every iteration of those 5 bills/coins, 2+2+1+1+1 . . . 2+2+1+1 . . . 2+2+1 . . . until it identifies the combination that gets closest to the target amount. Of course, the parameters of the matching algorithm can be adjusted based on the specific application and desired results of the users. It is most likely that a threshold between 60% and 90% will provide the best results in most situations.

Target amounts have default gain/Loss thresholds (+/−10% for example) that are set by the user, in the manner set forth below, to identify potential swap partners that match within a certain tolerance. The compare to target amount baseline is happening every time a bill is added. A match can be identified before all the bills are calculated but the algorithm continues until the best match (highest % of the target sum; lowest gain/loss delta) is identified. The Trade match can be presented to either or both potential parties in each of their wanted currencies along with data showing a percentage of total value they are looking to swap (+gain/loss) and each party is free to trade with the other. The acceptance and clearing of a trade are described below. For this example, with 1 euro=$1.10 and gain/loss tolerance set at 10%, the recommendation would be for each to trade 100 for 100 with a 10% gain for the party holding dollars and a 10% loss for the party holding euro. Of course, the various thresholds and other parameters of the algorithm can be adjusted based on the specifics of the platform, the trade, and the parties.

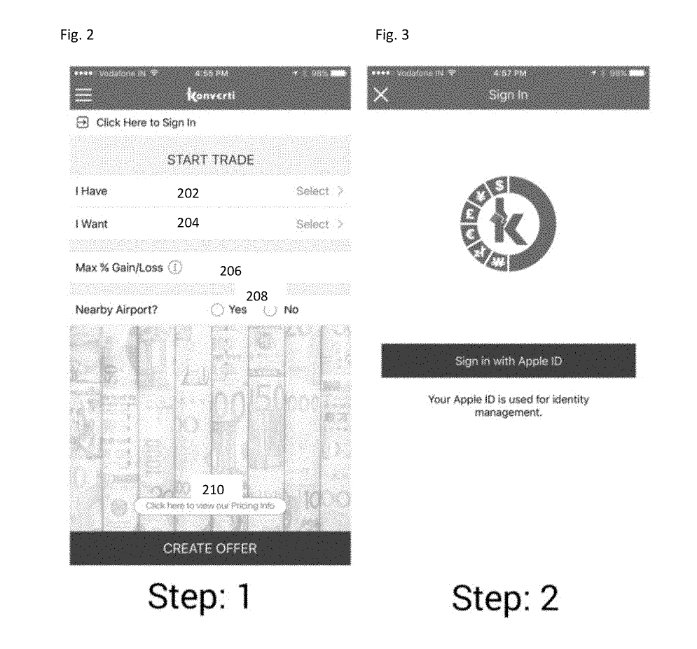

FIGS. 2-110 illustrate examples of a user interface presented to a user on a user device during a transaction. As shown in FIG. 2, a user can enter the originating currency that they have in field 202 and the target currency they desire to trade for in field 204. In field 206, the user can enter the maximum gain or loss that they will accept. As will become apparent below, default values for some of this information can be stored in association with the user account. The user can also enter their location, in this example by selecting a nearby airport using buttons 208. Pricing information and standard exchange rates can be viewed by selecting button 210. Assuming the user has not yet logged in, the user will be directed a login page. As illustrated in FIG. 3, the user can be prompted to log in through a predefined account to identify the user to the platform. FIG. 4 illustrates the user profile information that is applied to transaction matching as a default. This information, such as maximum loss/gain, can be changed for any transaction.

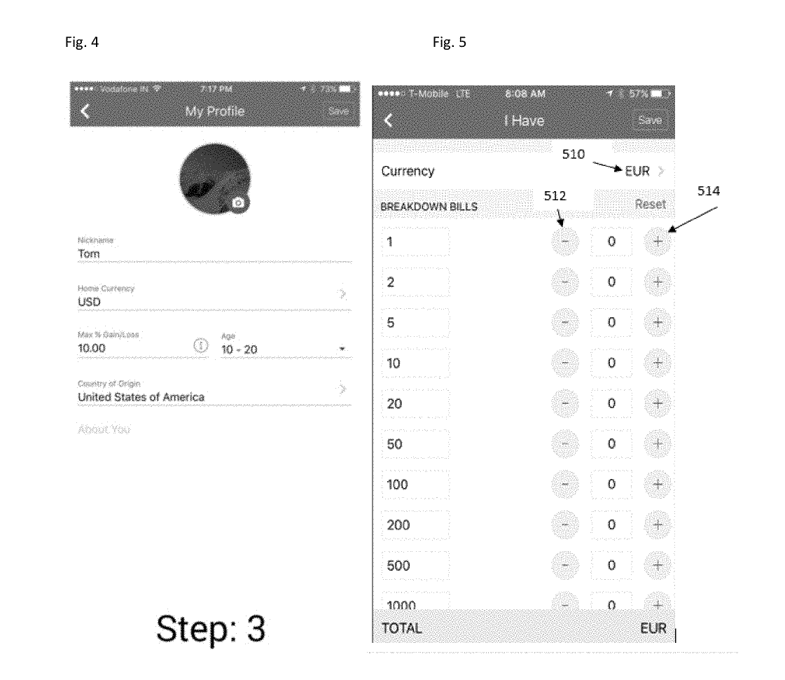

As described below, the matching algorithm processes the quantity and denomination of currency that users have for exchange. FIG. 5 shows an example of a user interface for entry of quantity and denominations. The user can select they type of currency at 510 and add or subtract quantitates to each denomination by activating buttons 512 and 514.

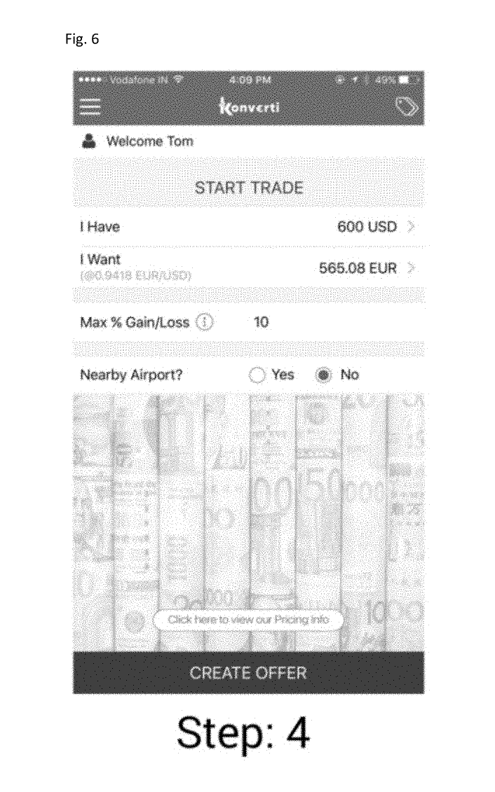

In FIG. 6, the user interface has returned to the screen of FIG. 2, but now in a logged in mode with the username of the user displayed. The fields can be populated with values entered before logging in (FIG. 2) or the values can be entered at this time. Upon entry, the information is sent to server 100 as a currency exchange request message.

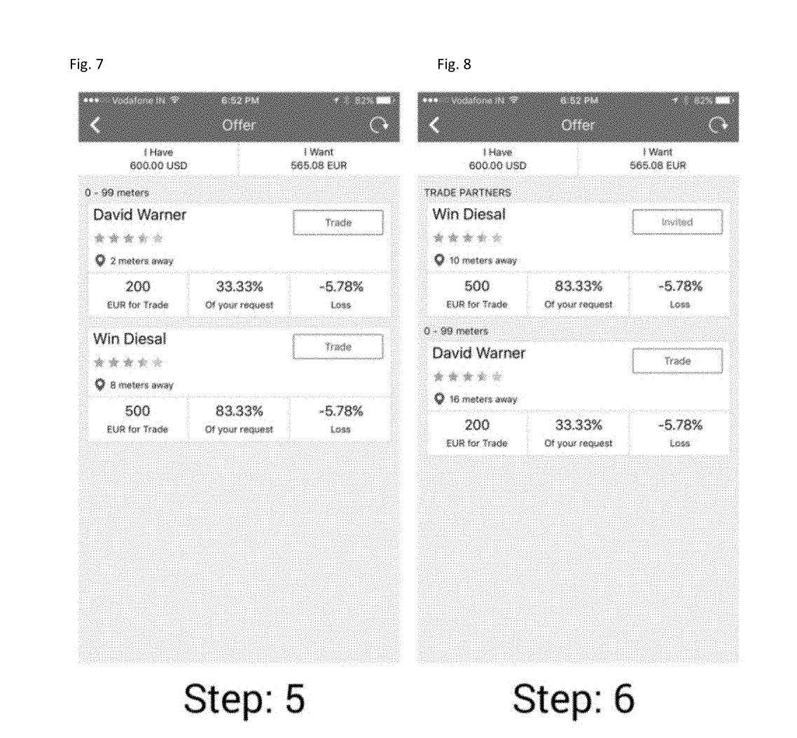

FIG. 7 shows a transaction proposal form displayed on the user device. The user, as a party, is offered a selection from among two different potential counterparties based on the matching algorithm executed by matching module 104, in the manner described above for example. Note that both the transaction associated with the username Win Diesal and the transaction associated with the username David Warner are for the type of currency requested by the user. The distinction between the two transactions is that Win Diesal can buy a larger percentage of the desired currency for sale. In FIG. 8, the user has selected the transaction associated with the username Win Diesal as the transaction that is approved. Note that the user interfaces of FIG. 7 and FIG. 8 display, for each proposed transaction, the amount and type of originating and target currency for trade the percent of requested trade satisfied, the gain/loss, and the current distance of the potential counterparty from the party.

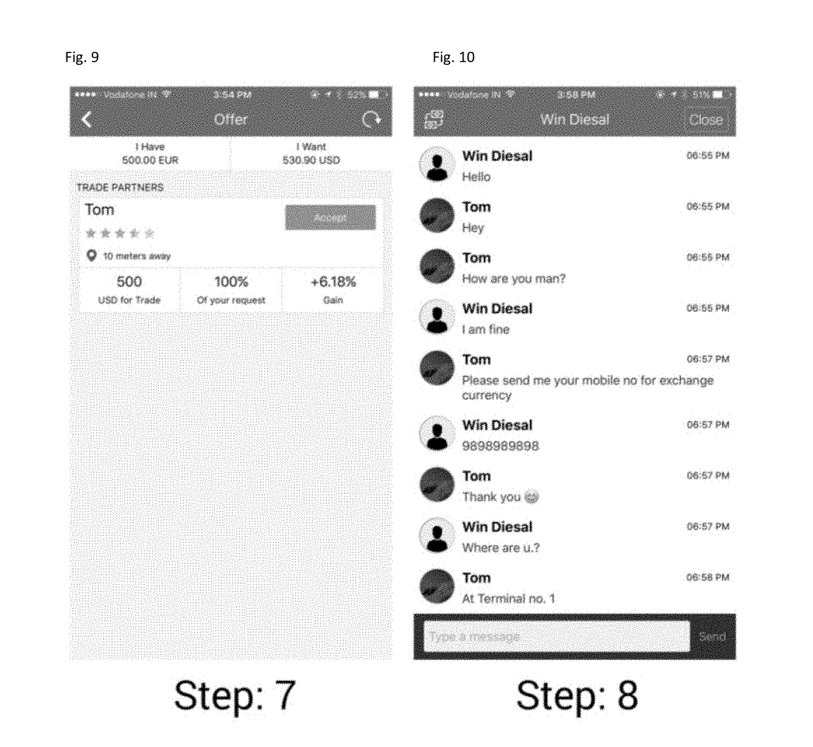

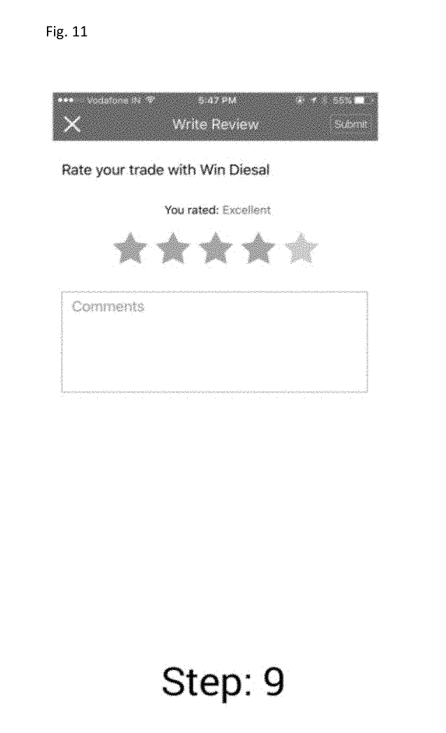

In FIG. 9, the user interface of the selected counterparty, Win Diesal, displays a message indicating that the counterparty has been matched to a party and that the party has selected the counterparty. If the counterparty accepts the transaction, the counterparty and the party are put into communication through a chat, as shown in FIG. 10, or another communication channel. At this time, server 100 can be notified of the transaction for accounting purposes as discussed above. The communication channel is used by the party and counterparty to arrange physical exchange of the currencies. FIG. 11 shows a rating user interface that can be displayed on the device of the party and the counterparty after the transaction to rate each other.

The various messages can be sent as a single message or multiple messages. For example, the information in the currency exchange request message can be sent in part from the user at the time of requesting a transaction and in part at a previous or subsequent time. Various workflows can be used for notify the parties of a match and for receiving acceptance of the transaction. For example, the party can be notified and the party can then send notification to a potential counterparty or both parties can be notified directly.

It will be appreciated by those skilled in the art that changes could be made to the embodiments described above without departing from the broad inventive concept thereof. It is understood, therefore, that this invention is not limited to the embodiments disclosed, but it is intended to cover modifications within the spirit and scope of the present invention as defined by the appended claims.

What is claimed:

1. A computer-implemented method for matching parties for a currency exchange transaction, the method comprising:
storing account information for each of multiple users, the account information including identity information of the corresponding user;
receiving currency exchange request messages from at least two of the multiple users, wherein each currency exchange request message includes information indicating the account of the user an origination currency, a target currency, and a currency value of either the origination or the target currency desired for trade;
storing the information in each request in a database as a match pool;
matching a first currency exchange request message with a second currency exchange request message based on the information in the match pool;
identifying the user corresponding to the first currency exchange request as a party and the user corresponding to the second currency exchange request as a counter-party;
transmitting a transaction proposal for the currencies indicated in the first currency exchange request to the party;
receiving acceptance of the proposal from the party; and
providing a mechanism for the party to contact the counterparty to thereby permit a peer to peer currency trade between the parties.

2. The method of claim 1, wherein each currency exchange request message further includes a maximum amount of gain or loss that will be accepted by the corresponding user and specific currency denominations and quantities.

3. The method of claim 1, further comprising:
transmitting a transaction proposal for the currencies indicated in the first currency exchange request to the counterparty; and
receiving acceptance of the proposal from the counterparty.

4. The method of claim 1, wherein the currency trade between the parties is cleared by physically exchanging the currency directly between the parties.

5. The method of claim 2, wherein the step of matching comprises:
determining match messages by comparing origination currency in a first message from a device associated with a first party with target currency in a second message from a device associated with a second party;
establishing a baseline currency value base on the lower of currency values specified in the first and second messages.
adding currency values starting with the highest denomination specified in the first message and proceeding downward in value toward the lowest denomination specified in the first message until the sum gets to predetermined threshold percentage of the baseline currency value;
adding currency values starting with the lowest denomination and proceeding towards the highest denomination specified in the first message until a predetermined number of coins/bills remain;
iterating trough every combination of the remaining coins/bills to identify a combination that brings the total of the results of the two adding steps and a total value of the combination within a specified percentage of the target amount.

6. The method of claim 5, wherein the iterating step comprises comparing the percentage difference between the baseline value and the total value of the combination to maximum amount of gain or loss specified in the first and second messages and determining a match when the percentage difference is within the maximum amount of gain or loss specified in the first and second messages.
